(19) United States
(12) Patent Application Publication
(10) Pub. No.: US 2019/0320148 A1
(43) Pub. Date: Oct. 17, 2019

(54) PROJECTION APPARATUS, CONTROL METHOD, AND NON-TRANSITORY STORAGE MEDIUM

(71) Applicant: CANON KABUSHIKI KAISHA, Tokyo (JP)

(72) Inventor: Kousei Sugimoto, Atsugi-shi (JP)

(21) Appl. No.: 16/381,724

(22) Filed: Apr. 11, 2019

(30) Foreign Application Priority Data
Apr. 13, 2018 (JP) 2018-077727
Jan. 21, 2019 (JP) 2019-007693

(51) Int. Cl. H04N 9/31

(52) U.S. Cl. CPC H04N 9/3155; H04N 9/3105; H04N 9/3182; H04N 9/3147

(57) ABSTRACT

A projection apparatus, among a plurality of projection apparatuses configured to project a plurality of projection images side by side as a single image, includes a light emission unit, a control unit configured to control the light emission unit to emit a light amount based on brightness of a first image, and a projection unit configured to modulate light emitted from the light emission unit based on the first image and project an image onto a projection plane, wherein the control unit is configured to control the light amount of the light emission unit based on the brightness of a first region of the first image, the first region adjoining a second image projected by another projection apparatus.

### BACKGROUND OF THE INVENTION

### Field of the Invention

The present disclosure generally relates to a projection apparatus, a control method, and a program.

### Description of the Related Art

To project an image of higher resolution or greater size, images can be output by a projection method called multiple projection that uses a plurality of projection apparatuses. The multiple projection is a method for connecting projection planes projected by a plurality of projection apparatuses to display a single image.

There is a technique called dynamic contrast that changes the amount of light incident from a light source upon modulation elements based on an input image. This technique reduces black luminance by reducing the amount of light in displaying a dark image.

Japanese Patent Application Laid-Open No. 2007-178772 and Japanese Patent No. 6093103 discuss techniques for reducing a difference in luminance at the border between the connected projection planes by adjusting the light amounts of the respective projection apparatuses to the same value in implementing dynamic contrast during multiple projection.

### SUMMARY OF THE INVENTION

According to an aspect of the present disclosure, a projection apparatus, among a plurality of projection apparatuses configured to project a plurality of projection images side by side as a single image, includes a light emission unit, a control unit configured to control the light emission unit to emit a light amount based on brightness of a first image, and a projection unit configured to modulate light emitted from the light emission unit based on the first image and project an image onto a projection plane, wherein the control unit is configured to control the light amount of the light emission unit based on the brightness of a first region of the first image, the first region adjoining a second image projected by another projection apparatus.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration of a projection system.

FIG. 2 is a diagram illustrating an example of a hardware configuration of a projection apparatus.

FIG. 3 is a diagram illustrating details of an example of a dynamic contrast (DC) processing unit.

FIGS. 4A and 4B are diagrams illustrating an example of an original image.

FIGS. 5A, 5B, and 5C are diagrams for describing an example of a situation where an issue occurs.

FIGS. 6A to 6D are diagrams for describing an example of processing by the projection system.

FIGS. 7A, 7B, and 7C are diagrams for describing an example of a situation where an issue occurs.

FIG. 8 is a diagram for describing an example of a situation where projected images overlap with each other.

FIGS. 9A to 9F are diagrams for describing an example of processing by a projection system.

FIG. 10 is a diagram illustrating an example of a system configuration of a projection system.

FIGS. 11A and 11B are diagrams for describing examples of specific regions.

FIG. 12 is a diagram illustrating details of an example of a DC processing unit.

FIGS. 13A to 13E are diagrams for describing an example of processing by a projection system.

FIG. 14 is a diagram illustrating details of an example of a DC processing unit.

FIG. 15 is a chart illustrating an example of a gradation conversion characteristic.

FIGS. 16A, 16B, and 16C are diagrams for describing an example of a luminance deviation.

FIG. 17 is a chart illustrating an example of the gradation conversion characteristic.

FIG. 18 is a chart illustrating examples of the gradation conversion characteristic.

### DESCRIPTION OF THE EMBODIMENTS

Exemplary embodiments of the present disclosure will be described in detail below with reference to the drawings.

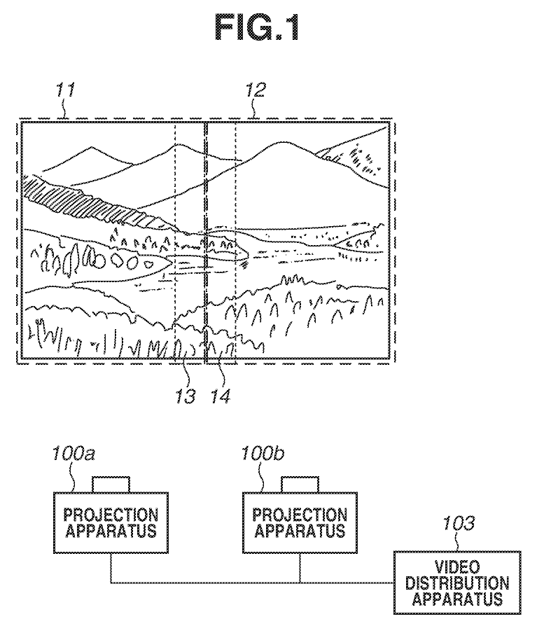

A first exemplary embodiment will be described below. FIG. 1 is a diagram illustrating an example of a system configuration of a projection system according to the present exemplary embodiment. The projection system is a multiple projection system that projects an image onto a projection plane using a plurality of projection apparatuses.

The projection system includes a projection apparatus 100a, a projection apparatus 100b, and a video distribution apparatus 103 as its components. The projection apparatus 100a and the projection apparatus 100b may hereinafter be referred to collectively as projection apparatuses 100. The projection apparatus 100a and the projection apparatus 100b are each connected to the video distribution apparatus 103. The projection apparatuses 100a and 100b are projectors or other projection apparatuses for projecting an image on a projection plane such as a screen and a white wall surface. The projection apparatuses 100 are examples of an information processing apparatus. The video distribution apparatus 103 is an information processing apparatus that divides an image to be projected onto the projection plane between an image to be projected by the projection apparatus 100a and an image to be projected by the projection apparatus 100b, and transmits the divided images to the respective projection apparatuses 100. Examples of the video distribution apparatus 103 include a personal computer, a server apparatus, and a tablet apparatus.

In the example of FIG. 1, a projection image 11 is projected by the projection apparatus 100a, and a projection image 12 is projected by the projection apparatus 100b. The projection image 11 and the projection image 12 are arranged to adjoin (tiled) on the projection plane, and thereby be combined into a single image. A partial region of the projection image 11 and a partial region of the projection image 12 may be arranged to overlap (edge-blended) on the projection plane, and thereby be combined into a single image.

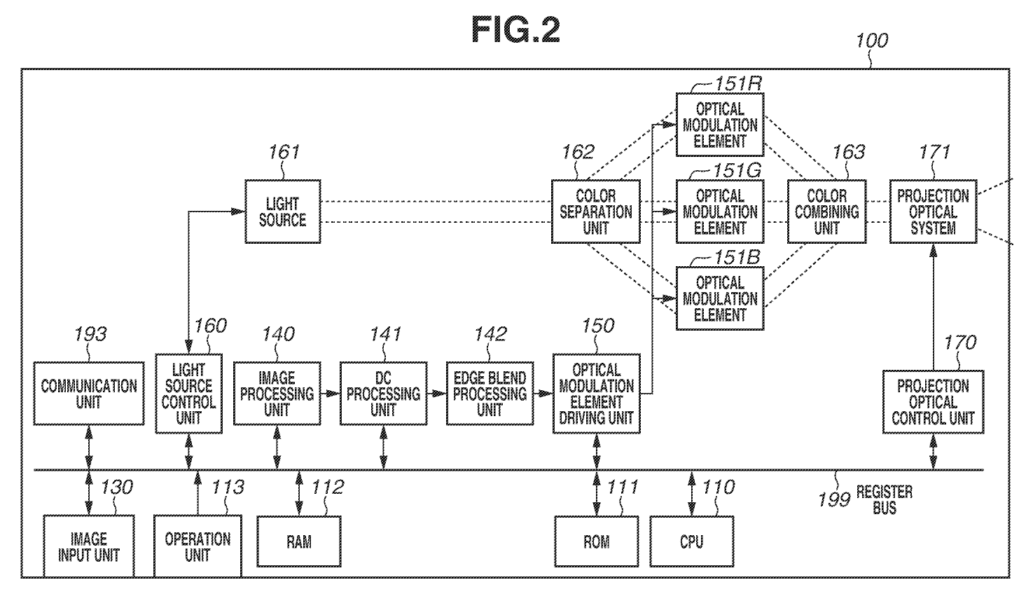

FIG. 2 is a diagram illustrating an example of a hardware configuration of the projection apparatuses 100.

Each projection apparatus 100 includes a central processing unit (CPU) 110, a read-only memory (ROM) 111, a random access memory (RAM) 112, an operation unit 113, an image input unit 130, an image processing unit 140, a dynamic contrast (DC) processing unit 141, and an edge blend processing unit 142. The projection apparatus 100 also includes an optical modulation element driving unit 150, optical modulation elements 151R, 151G, and 151B, a light source control unit 160, a light source 161, a color separation unit 162, a color combining unit 163, a projection optical control unit 170, a projection optical system 171, and a communication unit 193.

The CPU 110 is a central processing unit that controls the components of the projection apparatus 100. The ROM 111 is a storage device including a read-only memory for storing various control programs. The ROM 111 is an example of a computer-readable storage medium. The RAM 112 is a storage device including a random access memory functioning as a working memory of the CPU 110 and a temporary storage location for data and programs.

The operation unit 113 is an input device for accepting instructions from an operator (user) and transmitting an instruction signal to the CPU 110. Examples of the input device include a switch and a dial. The operation unit 113 may also include, for example, a signal reception unit (such as an infrared reception unit) for receiving a signal from a remote controller, and transmit a signal based on the signal received via the signal reception unit to the CPU 110. The CPU 110 receives signals input from the operation unit 113 and the communication unit 193, and controls the components of the projection apparatus 100.

The image input unit 130 is an interface used in receiving an image transmitted from an external apparatus. As employed herein, the external apparatus may be any apparatus that can output an image signal. Examples include a personal computer, a camera, a mobile phone, a smartphone, a hard disk recorder, and a game machine. The CPU 110 may obtain an image to be projected onto the projection plane by reading an image recorded on a medium connected to the projection apparatus 100, such as a Universal Serial Bus (USB) flash memory and a Secure Digital (SD) card. In such a case, the image input unit 130 serves as an interface to connect to the medium.

The image processing unit 140 is an image processing microprocessor that applies processing for changing the number of frames, the number of pixels, pixel values, and/or an image shape, to an image signal received from the image input unit 130, and transmits the result to the DC processing unit 141. The projection apparatus 100 may be configured without the image processing unit 140. In such a case, the CPU 110 implements functions similar to those of the image processing unit 140 and carries out the processing similar to that of the image processing unit 140 by performing the processing based on a program stored in the ROM 111.

The image processing unit 140 can perform processing such as frame decimation processing, frame interpolation processing, resolution conversion (scaling) processing, distortion correction processing (keystone correction processing), luminance correction processing, and color correction processing. The image processing unit 140 can also apply such processing to an image or video image reproduced by the CPU 110, aside from the image signal received from the image input unit 130.

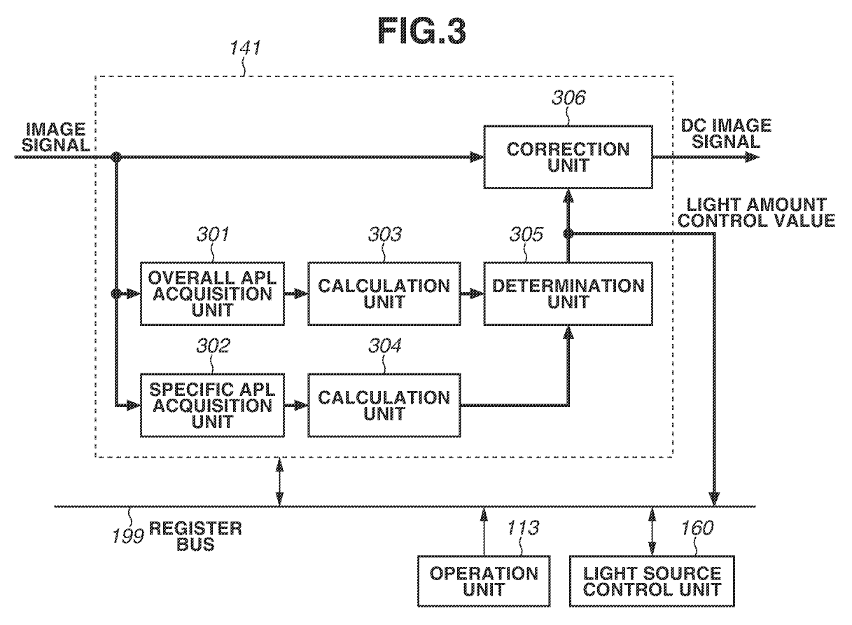

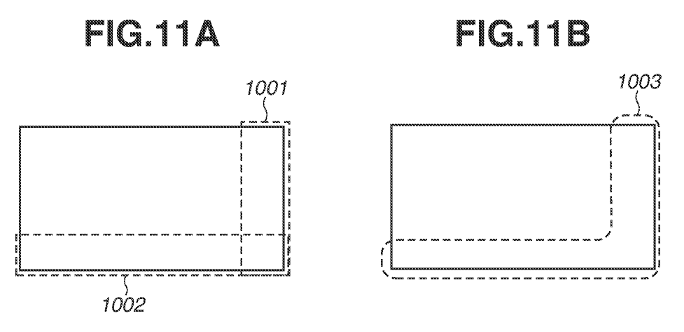

The DC processing unit 141 is an image processing microprocessor that generates an image to be transmitted to the edge blend processing unit 142 and a light amount control value to be transmitted to the light source control unit 160, from the image signal received from the image processing unit 140. The DC processing unit 141 performs processing based on a program stored in a storage device built in the DC processing unit 141, whereby functions of the DC processing unit 141 to be described below with reference to FIGS. 3 and 11 are implemented. The projection apparatus 100 may be configured without the DC processing unit 141. In such a case, the CPU 110 implements functions similar to those of the DC processing unit 141 to be described below with reference to FIGS. 3 and 11 and carries out the processing similar to that of the DC processing unit 141 by performing the processing based on a program stored in the ROM 111. Details of the DC processing unit 141 will be described below with reference to FIG. 3.

The edge blend processing unit 142 is a microprocessor that performs edge blend processing on the image (image signal) output from the DC processing unit 141 and outputs the processed image to the optical modulation element driving unit 150. The edge blend processing unit 142 performs the edge blend processing when projecting an image so that the image projected by the projection apparatus 100 and an image projected by the other projection apparatus 100 overlap as described above. Details of the control when performing a multiple display with the other projection apparatus 100 by using the edge blend processing will be described in a second exemplary embodiment. The projection apparatus 100 may be configured without the edge blend processing unit 142. In such a case, the CPU 110 implements functions similar to those of the edge blend processing unit 142 and carries out the processing similar to that of the edge blend processing unit 142 by performing the processing based on a program stored in the ROM 111.

The optical modulation element driving unit 150 is a mechanism for controlling voltages applied to liquid crystal elements of pixels of the optical modulation elements 151R, 151G, and 151B based on the image (image signal) output from the edge blend processing unit 142. By such processing, the optical modulation element driving unit 150 adjusts transmittance of the optical modulation elements 151R, 151G, and 151B. Light emitted from the light source 161 is modulated through the optical modulation elements 151R, 151G, and 151B. The light source 161 is an example of a light emission unit.

The optical modulation element 151R is a liquid crystal element corresponding to red. The optical modulation element 151R is an element that adjusts the transmittance of red light from among red (R), green (G), and blue (B) light beams into which white light output from the light source 161 is separated by the color separation unit 162. Similarly, the optical modulation element 151G is an optical modulation element that adjusts the transmittance of green light. The optical modulation element 151B is an optical modulation element that adjusts the transmittance of blue light. Examples of the optical modulation element 151R, 151G, and 151B include a liquid crystal panel and a digital mirror device (DMD).

The light source control unit 160 is a control microprocessor for controlling turn on/off of the light source 161 and controlling the amount of light from the light source 161. The projection apparatus 100 may be configured without the light source control unit 160. In such a case, the CPU 110 implements functions similar to those of the light source control unit 160 and carries out the processing similar to that of the light source control unit 160 by performing the processing based on a program stored in the ROM 111.

The light source 161 is a light source that outputs light for projecting an image onto the projection plane such as a screen. Examples of the light source 161 include a halogen lamp, a xenon lamp, a high-pressure mercury lamp, a light-emitting diode (LED), and a laser. The light amount of the light source 161 is an example of an index indicating the emission luminance of the light source 161.

The color separation unit 162 is a mechanism for separating the light output from the light source 161 into R, G, and B light beams. Examples of the color separation unit 162 include a dichroic mirror and a prism. If LEDs corresponding to the respective colors are used as the light source 161, the color separation unit 162 is not needed. In such a case, the projection apparatus 100 may be configured without the color separation unit 162.

The color combining unit 163 is a mechanism for combining the R, G, and B light beams transmitted through the optical modulation elements 151R, 151G, and 151B. Examples of the color combining unit 163 include a dichroic mirror and a prism. The light into which the R, G, and B components are combined by the color combining unit 163 is delivered to the projection optical system 171 and projected onto the screen.

The projection optical control unit 170 is a control microprocessor that controls the projection optical system 171. The projection apparatus 100 may be configured without the projection optical control unit 170. In such a case, the CPU 110 implements functions similar to those of the projection optical control unit 170 and carries out the processing similar to that of the projection optical control unit 170 by performing the processing based on a program stored in the ROM 111.

The projection optical system 171 is a mechanism for projecting the combined light output from the color combining unit 163 on the screen. The projection optical system 171 includes a plurality of lenses and lens-driving actuators. The projection optical control unit 170 can enlarge and reduce the projected image and make focus adjustments by controlling the projection optical system 171 to drive the lenses by the actuators.

The communication unit 193 is an interface used to receive control signals, still image data, and/or moving image data from an external apparatus. Examples of the communication unit 193 include a wireless local area network (LAN) interface, a wired LAN interface, a USB interface, and a Bluetooth (registered trademark) interface. For example, if the image input unit 130 is a High-Definition Media Interface (HDMI) (registered trademark) terminal, the CPU 110 may perform Consumer Electronics Control (CEC) communication via the terminal. As employed herein, the external apparatus may be any apparatus that can communicate with the projection apparatus 100. Examples include a personal computer, a camera, a mobile phone, a smartphone, a hard disk recorder, a game machine, and a remote controller.

The image processing unit 140, the DC processing unit 141, the optical modulation element driving unit 150, the light source control unit 160, and the projection optical control unit 170 according to the present exemplary embodiment may be a single or a plurality of microprocessors that can perform processing similar to that of such components.

The CPU 110 can temporarily store the still image data and moving image data received by the communication unit 193 into the RAM 112, and reproduce respective images and moving images by using a program stored in the ROM 111.

FIG. 3 is a diagram illustrating details of an example of the DC processing unit 141. An example of a functional configuration of the DC processing unit 141 will be described with reference to FIG. 3.

The DC processing unit 141 includes an overall average picture level (APL) acquisition unit 301, a specific APL acquisition unit 302, a calculation unit 303, a calculation unit 304, a determination unit 305, and a correction unit 306.

The DC processing unit 141 has two control modes, namely, a normal display mode and a tile display mode. The normal display mode is a mode used in displaying a video image by one projection apparatus 100. The tile display mode is a mode used in displaying a video image by a plurality of projection apparatuses 100 as in FIG. 1. The CPU 110 determines the control mode of the DC processing unit 141 based on a specification about the control mode of the DC processing apparatus 141, given by the operator via the operation unit 113.

The overall APL acquisition unit 301 obtains a feature amount indicating the brightness of the entire image from the image signal input to the DC processing unit 141. The feature amount is an average picture value (APL), (average gradation value), for example. A gradation value is an index indicating the luminance of each pixel in the image. Other indexes indicating the luminance of each pixel in the image include a luminance value. In the present exemplary embodiment, the image signal input to the DC processing unit 141 is an 8-bit RGB signal. The gradation value is also expressed in eight bits. The image signal (magnitude of the gradation value) and a light intensity have a linear relationship therebetween. In other words, if the gradation value increases by a certain value, the light intensity of the corresponding light also increases by a value corresponding to that value. The APL detected by the overall APL acquisition unit 301 will hereinafter be referred to as an overall APL.

The specific APL acquisition unit 302 obtains a feature amount indicating the brightness of a partial region (specific region) of the image expressed by the image signal input to the DC processing unit 141. For example, the specific region is a region designated by the operator via the operation unit 113. For example, the CPU 110 sets the specific region for the specific APL acquisition unit 302 to obtain an APL based on a region specification given by the operator via the operation unit 113. Such processing is an example of region setting processing. In the present exemplary embodiment, the operator designates a region adjoining the projection image of the other projection apparatus 100 in the input image as the specific region via the operation unit 113. In the example of FIG. 1, the operator designates a region 13 as a specific region for the projection apparatus 100a, and a region 14 as a specific region for the projection apparatus 100b. The specific APL acquisition unit 302 of the projection apparatus 100a then detects the APL of the region 13 on the input image signal. Similarly, the specific APL acquisition unit 302 of the projection apparatus 100b detects the APL of the region 14. The region for a specific APL acquisition unit 302 to detect an APL will hereinafter be referred to as a specific region. The APL of a specific region will hereinafter be referred to as a specific APL.

In the projection image projected by each projection apparatus 100, a specific region refers to a partial region adjoining the projection image projected by the other projection apparatus 100. The method for designating the specific region is not limited to the foregoing. If a single image is projected by a plurality of projection apparatuses 100, specific regions may be set based on preset region information with reference to the positions (layout) of partial images projected by the projection apparatuses 100 in the image. For example, suppose that projection images projected by two projection apparatuses 100 are horizontally arranged to display a single image as illustrated in FIG. 1. In such a case, regions adjoining the projection images projected by the other projection apparatuses 100 may be each set as specific regions. A specific region is a region smaller than the entire projection image projected by each projection apparatus 100. For example, a specific region is 30% or less of the projection image in size.

The calculation unit 303 calculates a light amount control value Ba based on the overall APL detected by the overall APL acquisition unit 301. A light amount control value is a value indicating a percentage (0% to 100%) of the amount of light to be used when the projection apparatus 100 projects an image, with a predetermined reference amount of light as 100%. The light amount control value Ba is a value based on the brightness of the entire input image.

For example, the calculation unit 303 determines the light amount control value Ba by using the following Eq. 1:

Light amount control value Ba=overall APL/255×100. (Eq. 1)

The calculation unit 304 calculates a light amount control value Bb based on the APL detected by the specific APL acquisition unit 302. The calculation unit 304 calculates the light amount control value Bb, from the specific APL by using the following Eq. 2:

Light amount control value Bb=specific APL/255×100. (Eq. 2)

The light amount control value Bb is a light amount control value based on the brightness of the specific region in the input image.

The determination unit 305 determines a light amount control value Bc based on the control mode of the DC processing unit 141, the light amount control value Ba, and the light amount control value Bb. The light amount control value Bc is a control value to be used to control the amount of light from the light source 161. If the control mode of the DC processing unit 141 is the tile display mode, the determination unit 305 determines that the greater value between the light amount control values Ba and Bb is the light amount control value Bc. If the control mode of the DC processing unit 141 is the normal display mode, the determination unit 305 determines that the light amount control value Ba is the light amount control value Bc. In the present exemplary embodiment, the projection system compares the calculated light amount control values Ba and Bb and determines the light amount control value Bc for controlling the light source 161. However, in the tile display mode, the projection system may determine, for example, the light amount control value Bc based on the higher level between the overall and specific APLs. In the normal display mode, the projection system may determine the light amount control value Bc based on the overall APL.

The light source control unit 160 controls the light amount of the light source 161 based on the light amount control value Bc output from the determination unit 305.

The correction unit 306 multiplies the gradation value of each pixel in the input image by the reciprocal of the light amount control value Bc (if the light amount control value Bc is 25%, the reciprocal is 1/0.25=4). The correction unit 306 thereby corrects the gradation value of each pixel to correct the image. The correction unit 306 outputs the results of multiplication to the optical modulation element driving unit 150. The optical modulation element driving unit 150 controls the optical modulation elements 151R, 151G, and 151B based on the output signal. More specifically, the correction unit 306 makes corrections to increase the gradation values of the image signal to compensate for a drop in the luminance of the projection image because of the amount of light emitted from the light source 161 which becomes smaller than when the light source 161 is driven by a light amount control value Bc of 100%. For example, if the light amount control value Bc is 25%, the correction unit 306 increases the gradation values approximately four times to suppress a drop in the luminance of the projection image. If a corrected gradation value exceeds the range of controllable gradation values, the correction unit 306 controls (saturates) the gradation value at the maximum value.

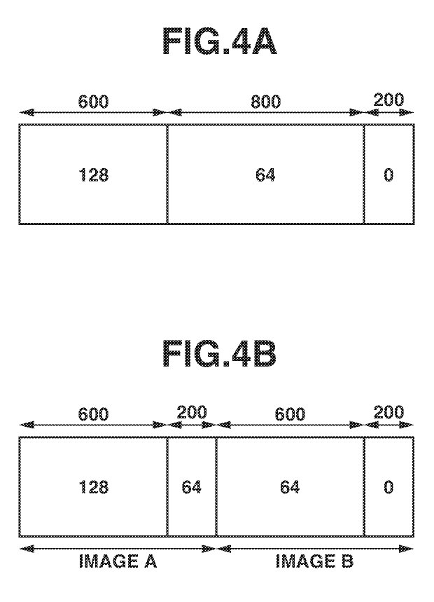

Next, the effects of light source control in the tile display mode according to the present exemplary embodiment will be described. FIGS. 4A and 4B are schematic diagrams illustrating an image to be displayed on the projection plane by the projection system illustrated in FIG. 1. FIG. 4A is a diagram illustrating an example of the image to be output by the projection system. The image illustrated in FIG. 4A is one yet to be divided by the video distribution apparatus 103. An image to be output by the projection system and yet to be divided by the video distribution apparatus 103 will hereinafter be referred to as an original image. The original image is an example of an output image to be projected and output by the projection system. In the example of FIG. 4, the original image is a grayscale image in which rectangular regions having a gradation value of 128, 64, and 0 are arranged in order from the left. The rectangular regions have a width of 600 pixels, 800 pixels, and 200 pixels in order from the left.

FIG. 4B is a diagram illustrating an example of image form where the original image is input from the video distribution apparatus 103 to the respective projection apparatuses 100. The images illustrated in FIG. 4B are ones into which the original image is divided to correspond to the respective projection apparatuses 100. The video distribution apparatus 103 divides the original image between an image A and an image B in the middle, and inputs the image A to the projection apparatus 100a and the image B to the projection apparatus 100b. The region having a gradation value of 128 in the image A will be referred to as a region RA1, and the region having a gradation value of 64 as a region RA2. The region having a gradation value of 64 in the image B will be referred to as a region RB1, and the region having a gradation value of 0 as a region RB2. The regions RA1, RA2, RB1, and RB2 have a horizontal length of 600 pixels, 200 pixels, 600 pixels, and 200 pixels, respectively.

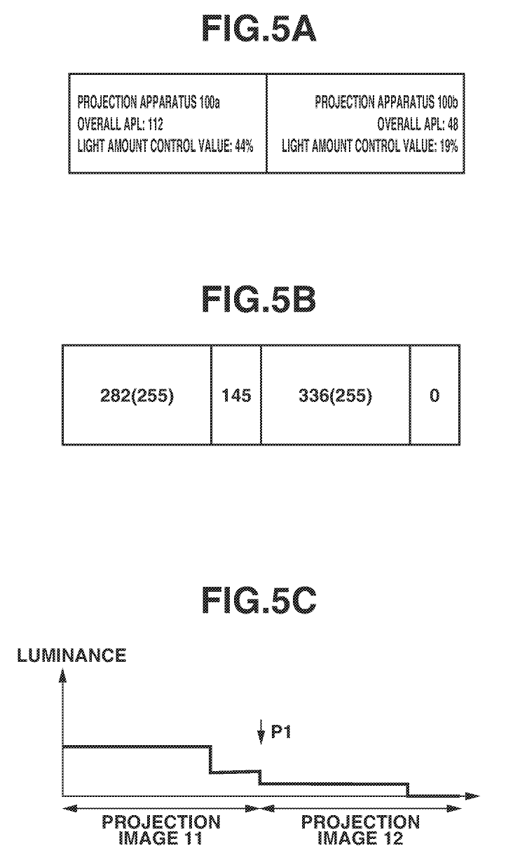

Suppose that light source control is not performed in the tile display mode described in the present exemplary embodiment, or equivalently, light source control is performed in the normal display mode. The light source control and a luminance distribution of images projected onto the projection plane in such a case will be described with reference to FIGS. 5A to 5C.

FIG. 5A illustrates the light amount control values Bc determined in the normal display mode. The overall APL of the image A input to the projection apparatus 100a is 112 (=(128×600+64×200)/800). The calculation unit 303 of the projection apparatus 100a determines that the light amount control value Ba is 44% by using Eq. 1. If the normal display mode is set, the determination unit 305 uses the light amount control value Ba as the light amount control value Bc. The overall APL of the image B input to the projection apparatus 100b is 48 (=(64×600+0×200)/800). As with the projection apparatus 100a, the determination unit 305 of the projection apparatus 100b determines that the light amount control value Bc is 19%.

The gradation values of the images A and B are corrected based on the light amount control values Bc determined as described above. By using the light amount control value Bc of 44%, the gradation value of the region RA1 having a gradation value of 128 in the image A is corrected to be 291 (=128/0.44). However, the gradation value of the region RA1 is limited to 255 since the range of controllable gradation values is 0 to 255. The gradation value of the region RA2 is corrected to be 145 (=64/0.44) by using the light amount control value Bc of 44%. By using the light amount control value Bc of 19%, the gradation value of the region RB1 is corrected to 336 (=64/0.19). Like the region RA1, the gradation value becomes saturated at 255. The gradation value of the region RB2 remains at 0. FIG. 5B is a schematic diagram illustrating the distribution of gradation values for controlling the optical modulation elements 151R, 151B, and 151G in the horizontal direction of the screens of the projection apparatuses 100. The regions RA2 and RB1 have different gradation values of 141 and 336 (255).

FIG. 5C is a diagram illustrating an example of the luminance values of the images A and B projected onto the projection plane by the projection apparatuses 100. The luminance on the projection plane is determined by the control value (degree of modulation, gradation value) of the optical modulation elements 151R, 151B, and 151G illustrated in FIG. 5B, and the light amount (control value) of the light source 161 of each projection apparatus 100. For example, the luminance on the projection plane is determined by the product of the control value (degree of modulation) of the optical modulation elements 151R, 151B, and 151G and the light mount (control value) of the light source 161 of the projection apparatus 100. Assume that the luminance value of light emitted from the light source 161 under a light amount control value Bc of 100% and modulated by the optical modulation elements 151R, 151B, and 151G controlled at a gradation value of 255 is 1. In such a case, the regions RA1, RA2, RB1, and RB2 have a luminance value of 0.4400, 0.2502, 0.1900, and 0.0019, respectively. Thus, as illustrated at position P1 in FIG. 5C, a difference is made in luminance level not present in the original image between the projection apparatuses 100 (between the regions RA2 and RB1). The reason why the region RB2 becomes brighter is that the optical modulation elements 151R, 151B, and 151G are characteristically unable to fully cut off light even at a gradation value of 0.

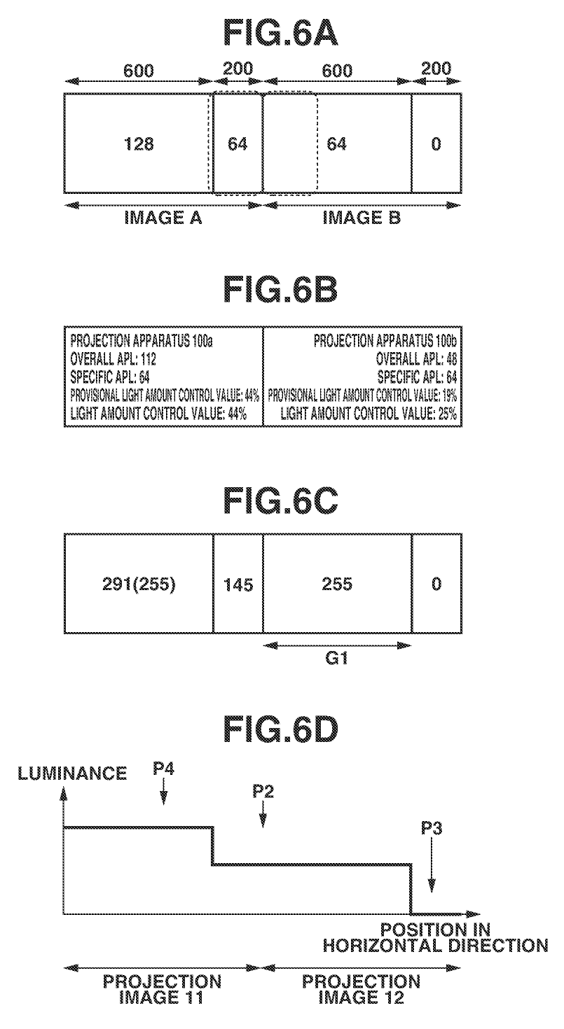

Next, the processing of the projection system according to the exemplary embodiment when the DC control units 141 of the projection apparatuses 100 are set to the tile display mode will be described with reference to FIGS. 6A to 6D.

FIG. 6A is a schematic diagram illustrating an example of the images A and B input from the video distribution apparatus 103 to the respective projection apparatuses 100. The regions illustrated by broken lines in FIG. 6A (a rectangular region TAc at the right end of the image A and a rectangular region TBc at the left end of the image B) are specific areas set for the respective projection apparatuses 100. In the present exemplary embodiment, both the specific regions TAc and TBc have a width of 200 pixels.

FIG. 6B illustrates the light amount control values Bc for the light sources 161 of the respective projection apparatuses 100 determined in the tile display mode. The overall APL of the image A input to the projection apparatus 100a is 112 (=(128×600+64×200)/800). The calculation unit 303 of the projection apparatus 100a determines that the light amount control value Ba is 44% by using Eq. 1. The specific region TAc of the image A input to the projection apparatus 100a has an APL (specific APL) of 64 (=(64×200)/200). The calculation unit 304 of the projection unit 100a determines that the light amount control value Bb is 25% by using Eq. 2. If the tile display mode is set, the determination unit 305 of the projection apparatus 100a uses the greater value between the light amount control values Ba and Bb as the light amount control value Bc. The light amount control value Bc of the projection apparatus 100a is thus determined to be 44%.

The overall APL of the image B input to the projection apparatus 100b is 48 (=(64×600+0×200)/800). The calculation unit 303 of the projection apparatus 100b determines that the light amount control value Ba is 19% by using Eq. 1. The specific region TBc of the image B input to the projection apparatus 100b has an APL (specific APL) of 64 (=(64×200)/200). The calculation unit 304 of the projection apparatus 100b determines that the light amount control value Bb is 25% by using Eq. 2. If the tile display mode is set, the determination unit 305 of the projection apparatus 100b uses the greater value between the light amount control values Ba and Bb as the light amount control value Bc. The light amount control value Bc of the projection apparatus 100b is thus determined to be 25%.

The gradation values of the images A and B are corrected based on the light amount control values Bc determined as described above. By using the light amount control value Bc of 44%, the gradation value of the region RA1 of the image A is corrected to be 291 (=128/0.44). Since the range of controllable gradation values is 0 to 255, the gradation value of the region RA1 is limited to 255. The gradation value of the region RA2 is corrected to be 145 (=64/0.44) by using the light amount control value Bc of 44%. By using the light amount control value Bc of 25%, the gradation value of the region RB1 is corrected to be 256 (=64/0.25). However, like the region RA1, the gradation value becomes saturated at 255. In addition, the gradation value of the region RB2 remains at 0. FIG. 6C is a schematic diagram illustrating the distribution of gradation values for controlling the optical modulation elements 151R, 151G, and 151B in the horizontal direction of the screens of the projection apparatuses 100. The regions RA2 and RB1 have different gradation values of 141 and 255, respectively.

FIG. 6D is a diagram illustrating an example of the luminance values of the images A and B projected onto the projection plane by the projection apparatuses 100. The regions RA1, RA2, RB1, and RB2 have a luminance value of 0.4400, 0.2502, 0.2500, and 0.0025, respectively. This can suppress the occurrence of a difference in luminance level that is not present in the original image but appears at position P1 of FIG. 5C.

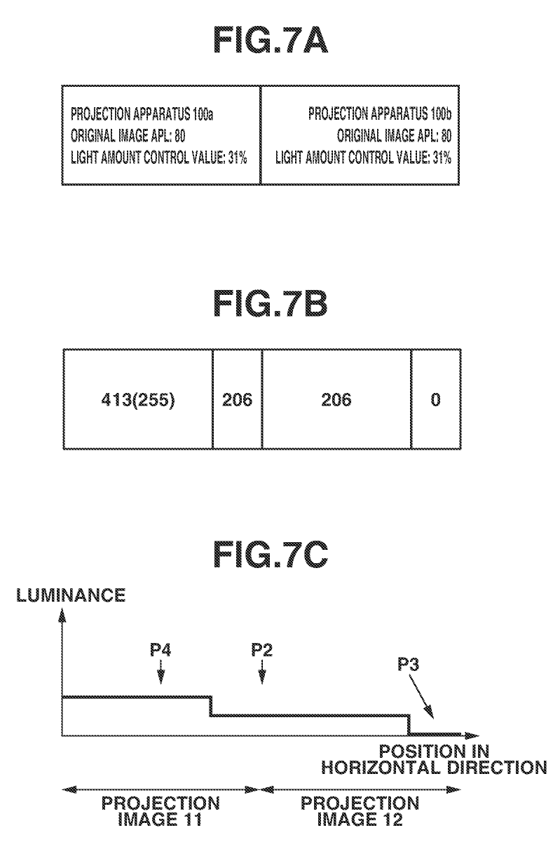

Next, a comparative example in which the light sources 161 of the projection apparatuses 100a and 100b are controlled by using the same light amount control value Bc will be described with reference to FIGS. 7A to 7C. In the comparative example, both the projection apparatuses 100a and 100b determine a common light amount control value Bc based on the APL of the original image. Suppose that the original image is the one illustrated in FIG. 4A. The original image has an APL of 80 (=(128×600+64×800+0×200)/1600). The projection apparatuses 100a and 100b determine that the light amount control value Bc is 31% by using the expression of (original image APL/255×100). The projection apparatuses 100a and 100b set the determined light amount control value Bc.

The projection apparatuses 100a and 100b correct the gradation values of the images A and B based on the light amount control value Bc determined as described above. By using the light amount control value Bc of 31%, the gradation value of the region RA1 of the image A is corrected to be 413 (128/0.31). Since the range of controllable gradation values is 0 to 255, the gradation value of the region RA1 is 255. The gradation value of the region RA2 is corrected to be 206 (=64/0.31) by using the light amount control value Bc of 31%. The gradation value of the region RB1 is also corrected to be 206 (=64/0.25). The gradation value of the region RB2 remains at 0. FIG. 7B is a schematic diagram illustrating the distribution of gradation values for controlling the optical modulation elements 151R, 151G, and 151B in the horizontal direction of the screens of the projection apparatuses 100. The regions RA2 and RB1 have a common gradation value.

FIG. 7C is a diagram illustrating an example of the luminance values of the images A and B projected onto the projection plane by the projection apparatuses 100. The regions RA1, RA2, RB1, and RB2 have a luminance value of 0.3100, 0.2504, 0.2504, and 0.0031, respectively. In such a case, the occurrence of a difference in luminance level at position P1 in FIG. 5C can be suppressed, whereas the region to display a black image (region RB2) has higher luminance and can be recognized as grayish black. The region having high luminance in the original image (region RA1) becomes lower in the luminance, compared to the foregoing two examples. This causes a drop in the contrast of the entire projection image.

By controlling the light sources 161 through the processing in the tile display mode described in the present exemplary embodiment, the occurrence of a difference in luminance level can be suppressed between the projection images projected by the respective projection apparatuses 100 while suppressing a drop in the contrast of the entire projection image displayed on the projection plane.

As described above, in the present exemplary embodiment, the projection system identifies the greater value of the average gradation values either in the entire region and in a specific region determined in advance inside an image to be projected by each projection apparatus 100. The projection system then determines the amount of light to be used when the projection apparatus 100 projects the image, based on the identified greater average gradation value. The projection system also determines how to adjust the gradation value of each pixel in the image when the projection apparatus 100 projects the image, based on the identified greater average gradation value. The projection system according to the present exemplary embodiment can thus adjust not only the light amount but also the gradation value of each pixel in the image. In other words, the projection system can determine the condition (light amount and gradation values) about image projection in more detail.

Through the processing according to the present exemplary embodiment, the projection system can reduce the influence of a difference in luminance between the images projected by the projection apparatuses 100. As seen at position P4 in FIG. 6, the projection system can also suppress a needless drop in luminance, compared to Japanese Patent Application Laid-Open No. 2007-178772 and Japanese Patent No. 6093103. As seen at position P3 in FIG. 6, the projection system can suppress an increase in black luminance, compared to Japanese Patent Application Laid-Open No. 2007-178772 and Japanese Patent No. 6093103. The projection system according to the present exemplary embodiment can thus reduce the influence of a difference in luminance between the projected images, suppress a needless drop in luminance, and suppress an increase in black luminance.

In the present exemplary embodiment, if the control mode of the DC processing unit 141 is the normal display mode, the projection system determines the light amounts based on the feature amounts of the entire input images. If the control mode of the DC processing unit 141 is the tile display mode, the projection system determines the light amounts based on the feature amounts of narrower regions designated within the images than the entire input images. The projection system can thus assist image projection more appropriately by switching the processing based on the set control mode. In the present exemplary embodiment, the APL of a specific region is used as the specific APL. However, for example, a set specific region may be divided into blocks, and an APL having the greatest value among the APLs calculated block by block may be used as the specific APL.

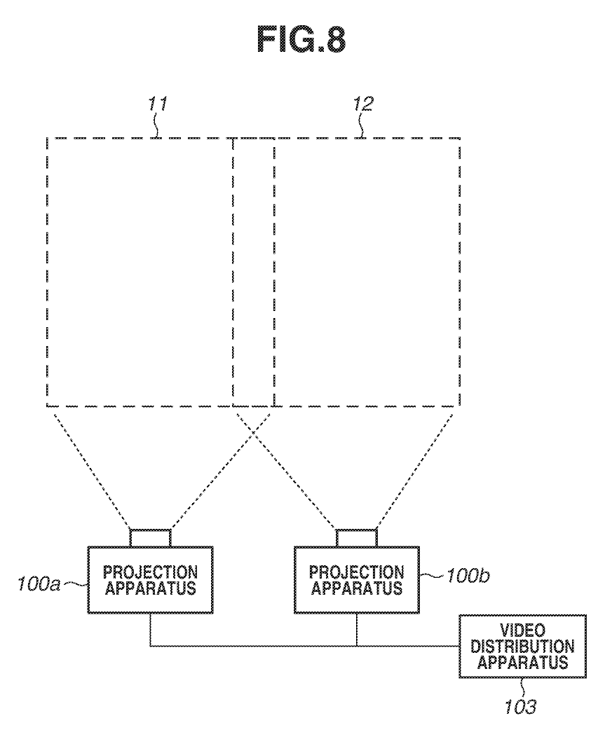

A second exemplary embodiment will be described below. In the first exemplary embodiment, the images are projected horizontally side by side for multiple projection. The present exemplary embodiment describes a case where the images projected by the respective projection apparatuses 100 partially overlap with each other as illustrated in FIG. 8.

The projection system according to the present exemplary embodiment has a system configuration similar to that of the first exemplary embodiment. The projection apparatuses 100 also have a hardware configuration similar to that of the first exemplary embodiment. The DC processing unit 141 of each projection apparatus 100 according to the present exemplary embodiment also has a functional configuration similar to that of the first exemplary embodiment.

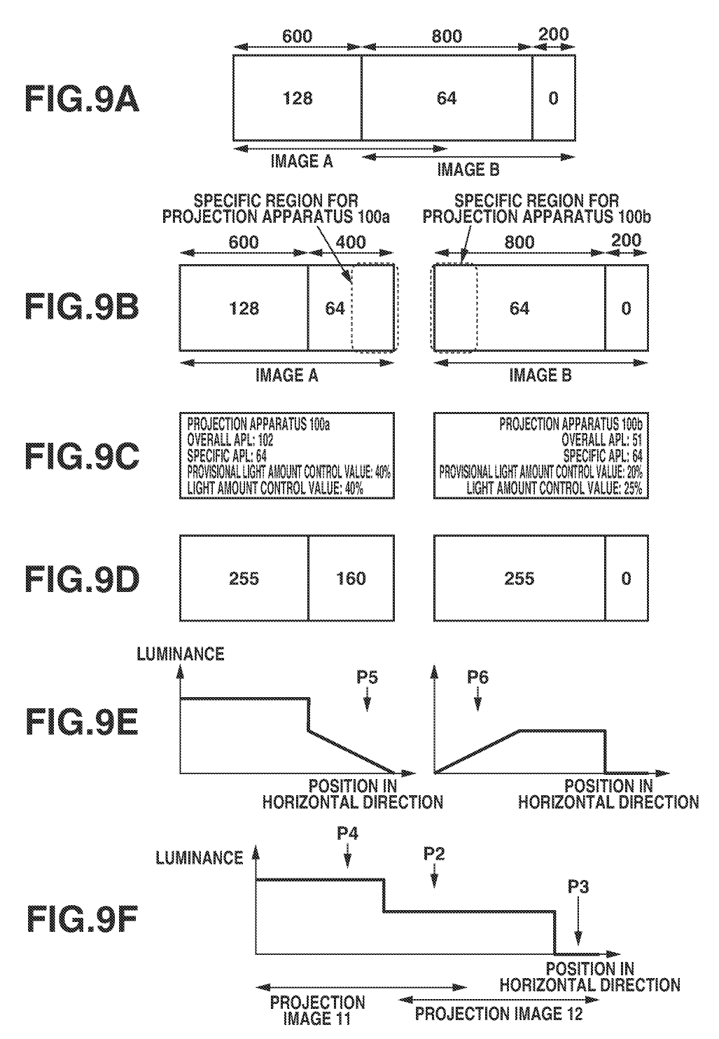

The processing according to the present exemplary embodiment will be described with reference to FIGS. 9A to 9F. Like FIG. 4A, FIG. 9A illustrates an image (original image) before the video distribution apparatus 103 divides the video image. FIG. 9B illustrates images that the video distribution apparatus 103 inputs to the respective projection apparatuses 100. Since the projected images overlap, a region (region having a width of 400 pixels) at the right end of the image A and a region (region having a width of 400 pixels) at the left end of the image B overlap with each other. In the present exemplary embodiment, a rectangular region having a width of 200 pixels at the right end of the image A is defined as the specific region in the image A (which is used by the projection apparatus 100a). A rectangular region having a width of 200 pixels at the left end of the image B is defined as the specific region in the image B (to be used by the projection apparatus 100b).

The projection apparatus 100a determines the light amount control value Bc through processing similar to that of the first exemplary embodiment, using the specific region set in the image A illustrated in FIG. 9B. The projection apparatus 100b determines the light amount control value Bc through processing similar to that of the first exemplary embodiment, using the specific region set in the image B illustrated in FIG. 9B. FIG. 9C illustrates the light amount control values Bc determined by the projection apparatuses 100.

Based on the determined light amount control values Bc, the projection apparatus 100a corrects the gradation value of each pixel in the image A to correct the image A through the processing similar to that of the first exemplary embodiment. Based on the determined light amount control values Bc, the projection apparatus 100b corrects the gradation value of each pixel in the image B to correct the image B through the processing similar to that of the first exemplary embodiment.

FIG. 9D is a diagram illustrating an example of the gradation values of the images corrected by the correction units 306. The left half of FIG. 9D is a diagram illustrating an example of the gradation values of the pixels of the image output from the DC processing unit 141 of the projection apparatus 100a. The right half of FIG. 9D is a diagram illustrating an example of the gradation values of the pixels of the image output from the DC processing unit 141 of the projection apparatus 100b.

FIG. 9E is a diagram illustrating an example of the luminance values of the images A and B projected onto the projection plane. The left chart of FIG. 9E indicates the luminance of the image A projected by the projection apparatus 100a. The right chart of FIG. 9E indicates the luminance of the image B projected by the projection apparatus 100b.

If the projected images overlap with each other, the edge blend processing units 142 of the respective projection apparatuses 100 perform edge blend processing on the image signals output from the DC processing units 141 so that the video images are blended naturally. The edge blend processing units 142 reduce the gradation value of each pixel corresponding to the regions where the images overlap with each other such that the closer the pixel comes to the center between the adjoining images (for example, a center point between the images, or a line that passes the center point between the rectangular images and is perpendicular to the sides of the rectangular images), the more the gradation value is reduced. As a result, the edge blend processing units 142 can correct the respective overlapping images. The edge blend processing units 142 thus correct the gradation values of the pixels corresponding to the regions where the images overlap such that the gradation values become smaller than in the images corrected by the correction units 306. The luminance on the projection plane is thereby also smoothly reduced as seen at positions P5 and P6.

A region where gradation values are thus reduced will hereinafter be referred to as an edge blend region. For example, the CPU 110 determines the edge blend region based on a designation given by the operator via the operation unit 113. The edge blend processing unit 142 may correct the gradation values of each image corresponding to the region where the images overlap in the following manner. The edge blend processing unit 142 may correct the gradation values of all the pixels in the portion where the images overlap by reducing the gradation values at a predetermined rate. For example, the edge blend processing unit 142 may correct the gradation values of all the pixels in the overlapping portion of each overlapping image by reducing the gradation values corrected by the correction unit 306 by half.

FIG. 9F is a diagram illustrating an example of the luminance on the projected images in a state where the projection image 11 (image A) and the projection image 12 (image B) are projected onto the projection plane such that the regions overlap with each other. As can be seen from FIG. 9F, there is no difference in luminance level at position P2. Compared to FIG. 5C, an increase in black luminance at position P3 is reduced. Unlike FIG. 5C, the luminance at position P4 is not lowered.

As described above, the projection system according to the present exemplary embodiment can suppress the appearance of a difference in luminance level between the projection images and suppress a drop in the contrast of the entire projection image displayed on the projection plane even if the images projected by the projection apparatuses 100 overlap as illustrated in FIG. 9.

In the present exemplary embodiment, the projection system performs the correction processing (edge blend processing) on the gradation values of the pixels in the image signals output from the DC processing units 141. However, for example, the video distribution apparatus 103 may perform the edge blend processing on the overlapping portions of the images A and B in advance. The projection system may perform the edge blend processing not by signal processing but by using an optical blending apparatus arranged between the projection apparatuses 100 and the projection plane. In addition, the projection system may omit the processing for setting the specific regions, by treating the regions to be subjected to the edge blend processing based on the operator's designation, as the specific regions. This can reduce the processing load.

A third exemplary embodiment will be described below. In the first exemplary embodiment, the two projection apparatuses 100 are described (projection apparatus 100a and projection apparatus 100b). The present exemplary embodiment describes a case where the number of projection apparatuses 100 is four.

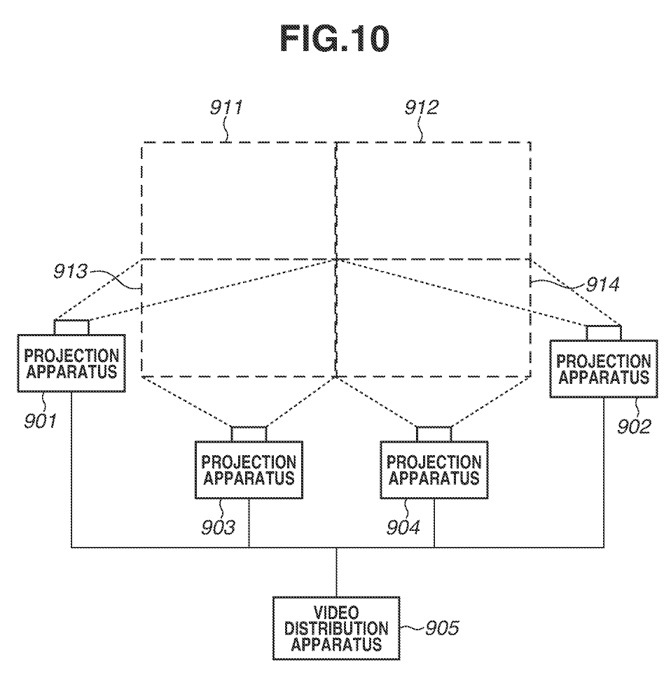

FIG. 10 is a diagram illustrating an example of a system configuration of a projection system according to the present exemplary embodiment. The projection system according to the present exemplary embodiment includes projection apparatuses 901 to 904 and a video distribution apparatus 905. In FIG. 10, the projection apparatuses 901 to 904 project projection images 911 to 914, respectively, to display a single image on the projection plane. The projection apparatuses 901 to 904 are connected to the video distribution apparatus 905. The video distribution apparatus 905 transmits images to be projected, to the respective projection apparatuses 901 to 904. The projection apparatuses 901 to 904 have a hardware configuration similar to that of the projection apparatuses 100 according to the first exemplary embodiment. The DC processing units 141 of the projection apparatuses 901 to 904 have a functional configuration similar to that of the DC processing units 141 of the projection apparatuses 100 according to the first exemplary embodiment.

In the first exemplary embodiment, the video distribution apparatus 103 divides an original image into left and right two images, and transmits the divided images to the respective projection apparatuses 100. In the present exemplary embodiment, the video distribution apparatus 905 divides an original image in half horizontally and in half vertically, i.e., into four images, and transmits the divided images to the respective projection apparatuses 901 to 904. In the present exemplary embodiment, the specific APL acquisition units 302 in the respective projection apparatuses 901 to 904 perform processing different from that of the specific APL acquisition units 302 in the projection apparatuses 100 according to the first exemplary embodiment.

In the present exemplary embodiment, an image projected onto the projection plane adjoins other images in two regions. The operator then designates two specific regions via the operation unit 113 of each of the projection apparatuses 901 to 904. FIG. 11A illustrates an example of the regions designated for the projection apparatus 901. In the example of FIG. 11A, a rectangular region at the right end of the image and a rectangular region at the bottom end are the regions to adjoin other images. The operator designates a region 1001 (rectangular region at the right end of the image) and a region 1002 (rectangular region at the bottom end of the image) as the specific regions. If an image adjoins another image at the left end or top end of the image, the operator designates a rectangular region at the left end of the image or a rectangular region at the top end of the image.

The specific APL acquisition unit 302 detects the APL in the region 1001 and the APL in the region 1002, and outputs the greater value as a final specific APL to the determination unit 305. Alternatively, the operator may designate an L-shaped specific region via the operation unit 113 of each of the projection apparatuses 901 to 904. FIG. 11B illustrates an example of a region 1003 designated in such a case. The specific APL acquisition unit 302 may output the APL in the region 1003 as a final specific APL to the determination unit 305.

As described above, by the processing according to the present exemplary embodiment, the projection system can suppress the occurrence of a difference in luminance level between the projection images and suppress a drop in the contrast of the entire projection image displayed on the projection plane even if the number of projection apparatuses is four. If there are more than four projection apparatuses, specific regions can be increased (or the shapes of the specific regions can be changed) in a similar manner.

A fourth exemplary embodiment will be described below. In the first to third exemplary embodiments, processing using the two APL acquisition units, namely, the overall APL acquisition unit 301 and the specific APL acquisition unit 302 of the projection apparatuses 100 has been described. The present exemplary embodiment describes processing using one APL acquisition unit. A projection system according to the present exemplary embodiment has a system configuration similar to that of the first exemplary embodiment. In addition, the projection apparatuses 100 according to the present exemplary embodiment have a hardware configuration similar to that of the first exemplary embodiment.

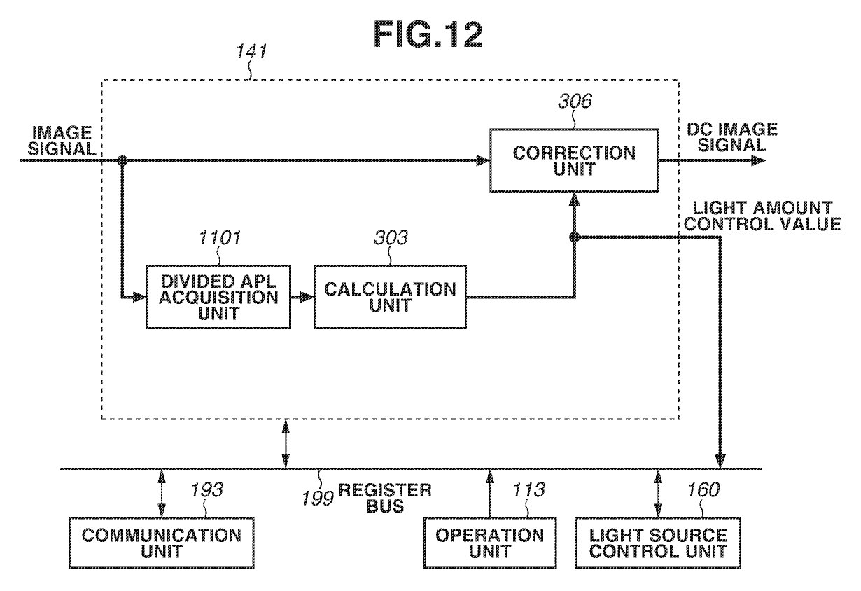

FIG. 12 is a diagram illustrating an example of a functional configuration of the DC processing unit 141 of the projection apparatuses 100 according to the present exemplary embodiment. The DC processing unit 141 includes a divided APL acquisition unit 1101, a calculation unit 303, and a correction unit 306. The calculation unit 303 and the correction unit 306 are similar to those of the first exemplary embodiment.

The divided APL acquisition unit 1101 divides the image input to the DC processing unit 141 in a predetermined division pattern (for example, in a pattern of dividing the entire image into eight columns and four rows of blocks, i.e., 32 blocks). The divided APL acquisition unit 1101 detects the APL in each block. If the control mode of the DC processing unit 141 is the tile display mode, the divided APL acquisition unit 1101 determines that the highest of the APLs of all the blocks is a representative value, and outputs the representative value as the feature amount of the entire image. If the control mode of the DC processing unit 141 is the normal display mode, the divided APL acquisition unit 1101 outputs an average of the APLs of all the blocks as the feature amount of the entire image.

The calculation unit 303 determines a light amount control value through processing similar to that of the first exemplary embodiment, using the feature amount of the entire image output by the divided APL acquisition unit 1101 instead of the overall APL. The calculation unit 303 outputs the determined light amount control value to the light source control unit 160 and the correction unit 306 as a final light amount control value, not a provisional one. The rest of the processing is similar to that of the first exemplary embodiment.

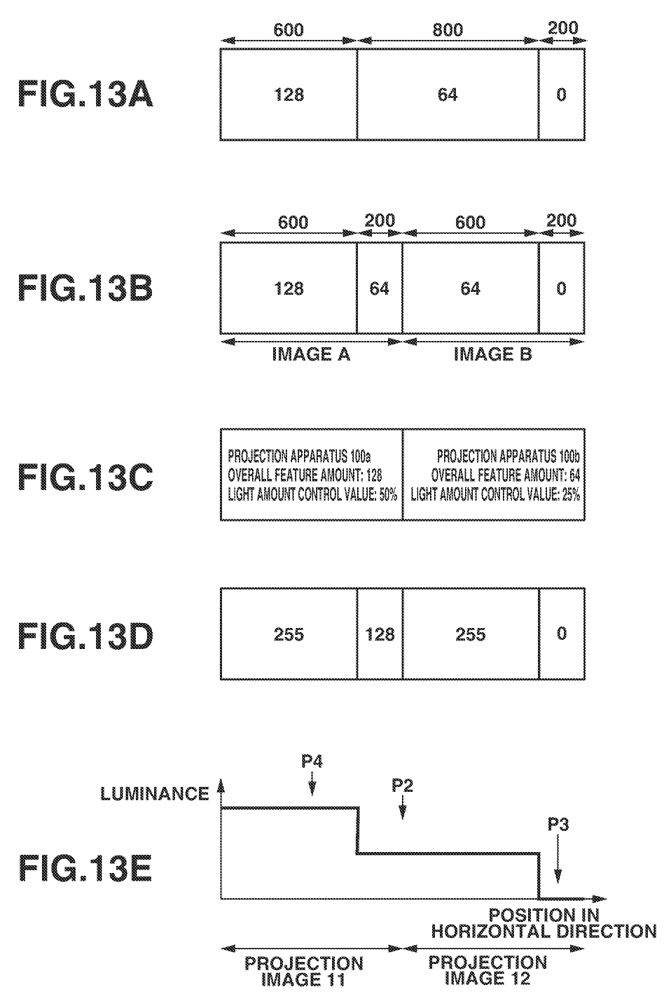

The processing according to the present exemplary embodiment will be described with reference to FIGS. 13A to 13E. Like FIG. 4A, FIG. 13A illustrates an example of the original image before divided by the video distribution apparatus 103. FIG. 13B illustrates the images A and B into which the original image is divided by the video distribution apparatus 103, and which are input to the respective projection apparatuses 100. FIG. 13C illustrates the light amount control values for the respective projection apparatuses 100. FIG. 13D illustrates the gradation values of the pixels in the images output from the DC processing units 141 of each projection apparatus 100. FIG. 13E illustrates the luminance of the projection images 11 and 12 projected onto the projection plane.

In the example of FIGS. 13A to 13E, each of the eight columns and four rows of blocks into which the image A is divided has an APL of 64 to 128 in value. The feature amount of the entire image A determined by the divided APL acquisition unit 1101 of the projection apparatus 100a is thus 128. Further, each of the eight columns and four rows of blocks into which the image B is divided has an APL of 0 to 64. The feature amount of the entire image B determined by the divided APL acquisition unit 1101 of the projection apparatus 100b is thus 64. As can be seen from FIG. 13E, a difference in luminance level at position P2, an increase in black luminance at position P3, and a drop in luminance at position P4 are reduced, compared to the cases of FIGS. 5A to 5C and 7A to 7C.

As described above, according to the present exemplary embodiment, the projection system controls the light amount and the gradation values based on the highest of the APLs in the plurality of blocks into which an image to be projected is divided. The projection system can thus assist more appropriately image projection by using a single APL acquisition unit.

In the present exemplary embodiment, the projection system divides an image into eight columns and four rows of blocks, i.e., 32 blocks. However, the projection system may divide an image, for example, pixel by pixel. In such a case, a single block corresponds to a single pixel. For example, a 300-by-400-pixel image is divided into 120000 blocks.

A fifth exemplary embodiment will be described below. The present exemplary embodiment describes processing when the correction unit 306 corrects the gradation values by a method different from the first to fourth exemplary embodiments. In the present exemplary embodiment, the processing of the edge blend processing unit 142 is performed before the processing of the DC processing unit 141 is performed.

A projection system according to the present exemplary embodiment has a system configuration similar to that of the first exemplary embodiment. The projection apparatuses 100 according to the present exemplary embodiment have a hardware configuration similar to that of the first exemplary embodiment. In the present exemplary embodiment, like the second exemplary embodiment, the images projected by the respective projection apparatuses 100 partially overlap with each other.

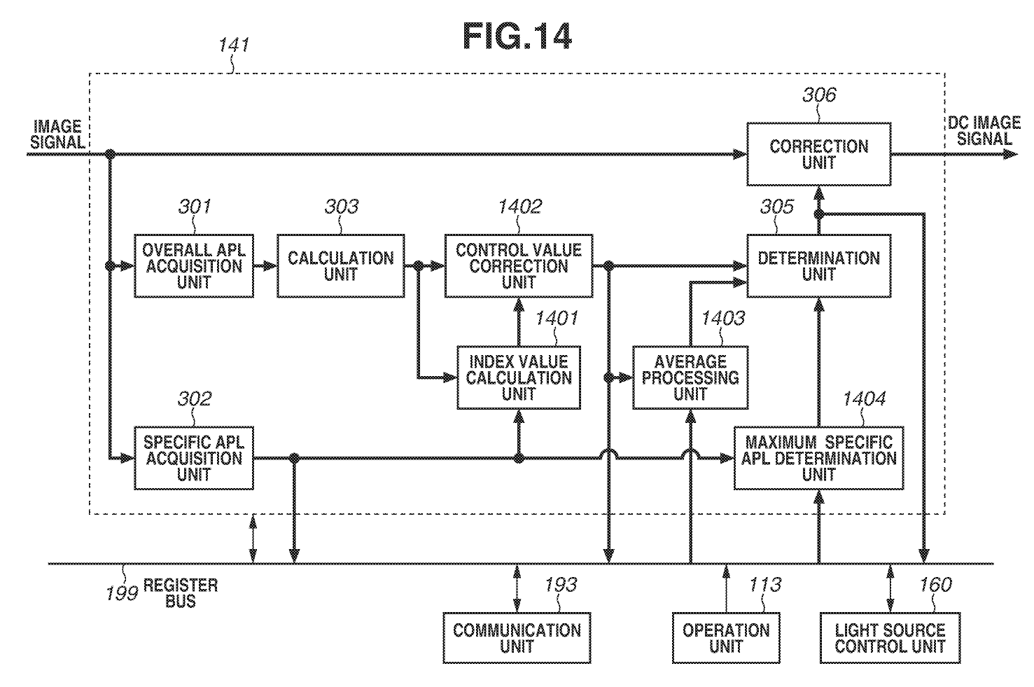

FIG. 14 is a diagram illustrating an example of a functional configuration of the DC processing unit 141 according to the present exemplary embodiment. The DC processing unit 141 includes an overall APL acquisition unit 301, a specific APL acquisition unit 302, a calculation unit 303, an index value calculation unit 1401, a control value correction unit 1402, an average processing unit 1403, a maximum specific APL determination unit 1404, a determination unit 305, and a correction unit 306. The overall APL acquisition unit 301, the specific APL acquisition unit 302, and the calculation unit 303 are similar to those illustrated in FIG. 3.

The determination unit 305 determines a light amount control value to be used for image projection, and outputs the determined light amount control value to the light source control unit 160 and the correction unit 306. The light amount control value determined by the determination unit 305 will hereinafter be referred to as a light amount control value Bc.

The correction unit 306 determines a gradation conversion characteristic based on the light amount control value Bc output from the determination unit 305, and converts the gradation value of each pixel of the input image based on the determined gradation conversion characteristic. The correction unit 306 then outputs the image showing the converted gradation value of each pixel, to the optical modulation element driving unit 150. As employed herein, the gradation conversion characteristic refers to a characteristic about conversion of gradation values. More specifically, the gradation conversion characteristic is information indicating how input gradation values (gradation values before conversion) are converted. In the present exemplary embodiment, the gradation conversion characteristic is information indicating the relationship between an input gradation value (gradation value before conversion) and an output gradation value (gradation value after conversion).

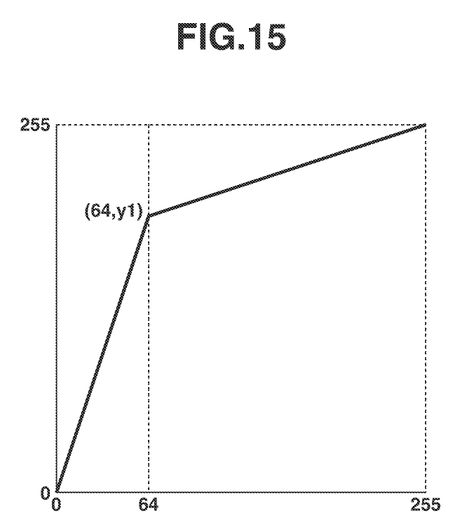

In the present exemplary embodiment, a method by which the correction unit 306 determines the gradation conversion characteristic will be described with reference to FIG. 15. The horizontal axis of the graph of FIG. 15 indicates the input gradation value (gradation value before conversion). The vertical axis indicates the output gradation value (gradation value after conversion). The correction unit 306 determines that input gradation values in the range of 0 or more and less than 64 are converted based on a straight line that passes the point (0, 0) and has a gradient of 1/(light amount control value Bc/100). The output gradation value for an input gradation value of 64 will be denoted by y1.

The correction unit 306 determines that input gradation values in the range of 64 or more and 255 or less are converted based on a straight line that passes the point (64, y1) and the point (255, 255). In such a manner, the correction unit 306 determines how input gradation values are converted, and generates the information indicating the determined conversion pattern as the gradation conversion characteristic.

In the first exemplary embodiment, if a corrected gradation value exceeds the range of controllable gradation values, the correction unit 306 controls (saturates) the gradation value to the maximum value. Details can be lost here since all saturated gradation values come to have the same value.

In the present exemplary embodiment, the correction unit 306 reduces loss of details by giving a gentle gradient to the output gradation values in the range of input gradation values of 64 or more and 255 or less. In other words, the correction unit 306 prevents input gradation values having a certain value or more from being all converted into 255.

The index value calculation unit 1401 determines an index value indicating the degree of deviation in luminance (hereinafter, referred to as luminance deviation) in which an edge blend region of the projected image becomes brighter than a region outside the edge blend region. The control value correction unit 1402 corrects a light amount control value.

The index value calculation unit 1401 and the control value correction unit 1402 perform processing for reducing the brightening (hereinafter, luminance deviation) of the edge blend region of the projected image compared to the region outside the edge blend region.

The edge blend processing unit 142 corrects the gradation values of the image in the edge blend region based on a predetermined blend ratio so that the overlapping projected portions will not become brighter than the non-overlapped portion. A luminance deviation can occur if the correction unit 306 converts the corrected image.

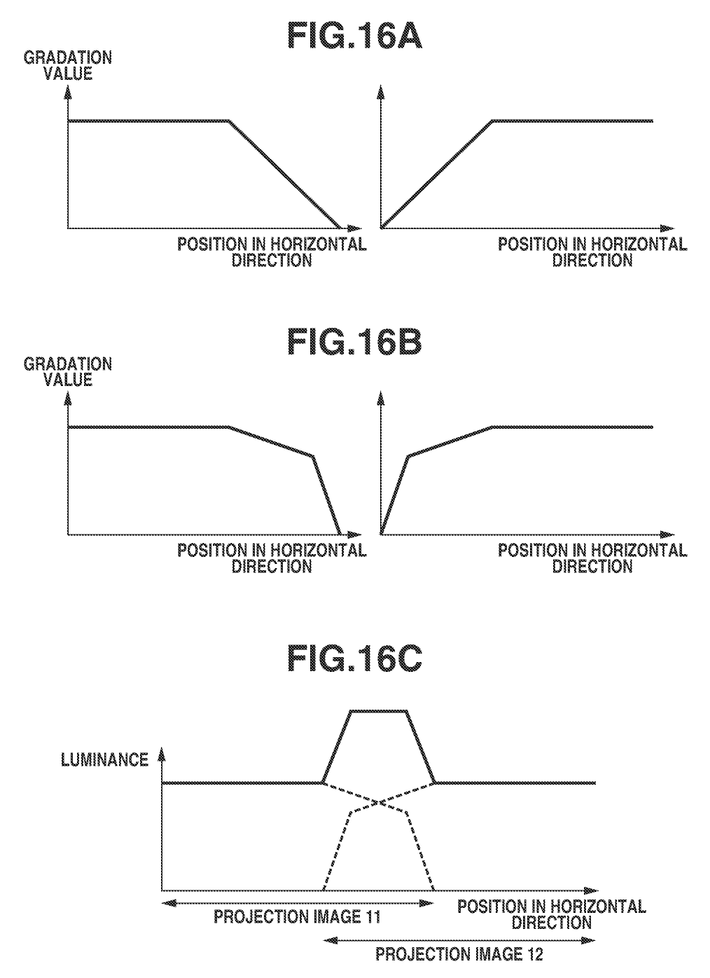

A case will be described in which the edge blend processing is performed on images having a constant gradation value and the resulting projection images are displayed in an overlapping manner, with reference to FIGS. 16A to 16C. FIG. 16A illustrates the gradation values of the images after the edge blend processing is performed. FIG. 16B illustrates the gradation values obtained by converting the gradation values of FIG. 16A based on the gradation conversion characteristic illustrated in FIG. 15.

In the example of FIG. 16A, the gradation values of the adjoining images decrease at a constant rate toward a center between the adjoining images. In the example of FIG. 16B, the gradation values of the adjoining images decrease toward the center between the adjoining images, bending on the way. If the images having the gradation values illustrated in FIG. 16B are projected in a partially overlapping manner, the resulting luminance values are not flat, and the luminance values in the overlapping regions become higher than in the other regions as illustrated in FIG. 16C. Such a deviation in luminance is referred to as a luminance deviation.

A luminance deviation occurs if the gradation conversion characteristic indicates a nonlinear conversion as in FIG. 15. No luminance deviation occurs if the gradation conversion characteristic indicates a linear conversion.

In the present exemplary embodiment, the index value calculation unit 1401 determines the index value indicating the degree of luminance deviation. The control value correction unit 1402 reduces the amount of luminance deviation by correcting the light amount control value (bringing the light amount control value closer to 100%) based on the index value determined by the index value calculation unit 1401. The amount of luminance deviation will hereinafter be referred to as a luminance deviation amount. The reason why a luminance deviation can be reduced by bringing the light amount control value closer to 100% is that the closer to 100% the light amount control value, the closer to linear the conversion indicated by the gradation conversion characteristic determined by the correction unit 306.

What degree of luminance deviation occurs depends on the gradation conversion characteristic, the gradation values of the pixels in the edge blend region before the edge blend processing is performed, the gradation values of the pixels in the edge blend region after the edge blend processing is performed, and the light amount. A luminance deviation appears as a difference between the brightness of the edge blend region and the brightness of the regions outside the edge blend region. The light amount is a factor multiplied by both the brightness of the edge blend region and the brightness of the regions outside the edge blend region. In the present exemplary embodiment, for ease of description, the luminance deviation amount is defined as a value calculated with a light amount of 1.

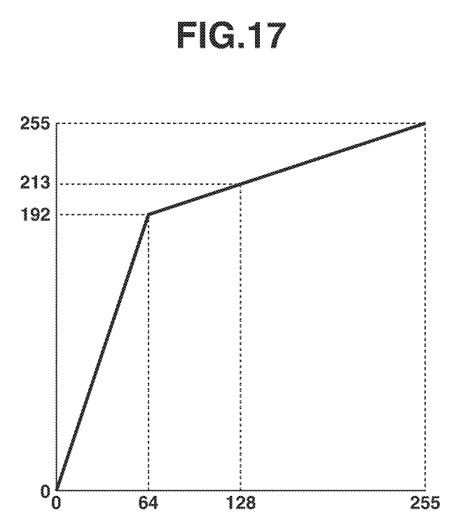

Now, processing of the projection system will be described when the gradation conversion characteristic determined by the correction unit 306 is the one illustrated in FIG. 17.

Suppose that in each of the images to be projected in the overlapping manner, a pixel at the center of the edge blend region before the edge blend processing is performed, has a gradation value GIbf of 128. If gradation conversion using the gradation conversion characteristic of FIG. 17 is performed on the pixel, the resulting gradation value GObf after the gradation conversion is 213. The gradation value GObf shows no luminance deviation since the gradation conversion is performed without the edge blend processing.

On the other hand, the gradation values drop after the edge blend processing is performed. The edge blend processing according to the present exemplary embodiment is processing for reducing the gradation values at a constant rate toward the center between the adjoining images. In the example of FIG. 17, the edge blend processing reduces the pixel value at the center of the edge blend region by half. In such a case, the resulting gradation value GIaf after the edge blend processing is ½ of the gradation value GIbf, or 64. If the gradation conversion is performed on the gradation value GIaf based on the gradation conversion characteristic of FIG. 17, the resulting converted gradation value GOaf is 192.

Two projection images overlap at the edge blend regions with each other. The value of the luminance deviation amount is thus a difference between twice the gradation value GOaf, and the gradation value GObf without luminance deviation, which is multiplied by the light amount.

Next, the relationship between the gradation value of a pixel before the edge blend processing, the gradation value of the pixel after the edge blend processing, and the luminance deviation amount will be described.

The gradation conversion characteristic according to the present exemplary embodiment is linear in the range where the input gradation value (unconverted gradation value) is 0 or more and less than 64. Because of such a characteristic, the luminance deviation amount (GOaf×2−GObf) becomes zero and no luminance deviation occurs if the gradation value GIbf before the edge blend processing is less than 64 (i.e., if the gradation value GIaf after the edge blend processing is less than 32).

If the gradation value GIbf before the edge blend processing falls within the range of 64 or more and less than 128, the luminance deviation amount (GOaf×2−GObf) increases as the gradation value GIbf increases. The greater the gradation value GIbf, the greater the luminance deviation amount (GOaf×2−GObf).

If the gradation value GIbf before the edge blend processing falls within the range of 128 or more and 255 or less, the luminance deviation amount (GOaf×2−GObf) takes a constant value (in the example of FIG. 17, 171) regardless of the value of the gradation value GIbf. The constant value indicates the gradation value when the luminance deviation amount is maximum.

As described above, the greater the gradation value GIbf before the edge blend processing, the greater the luminance deviation amount (GOaf×2−GObf). The same applies if the gradation conversion characteristic indicates a monotonously increasing characteristic. That is, the greater the gradation value GIbf before the edge blend processing, the greater the luminance deviation amount (GOaf×2−GObf).

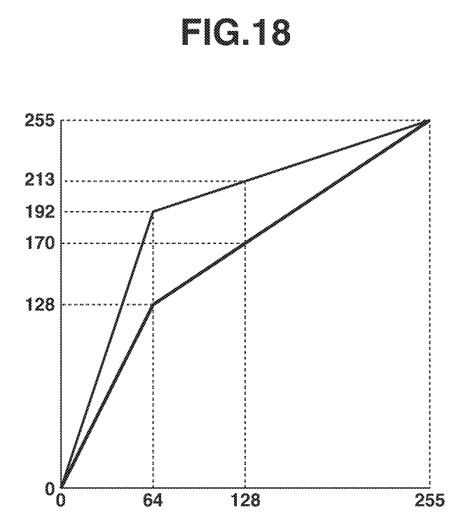

Next, the relationship between the light amount control value and the luminance deviation amount will be described with reference to FIG. 18. The thick line in FIG. 18 indicates the gradation conversion characteristic for a light amount control value of 50%. The thin line in FIG. 18 indicates the gradation conversion characteristic for a light amount control value of 33%. Suppose that in each of the images projected in an overlapping manner, the gradation value GIbf of the pixel at the center of the edge blend region is 128 and the gradation value GIaf is 64. If the light amount control value is 50%, GObf is 170 and GOaf is 128. The luminance deviation amount (GOaf×2−GObf) is 86. On the other hand, if the light amount control value is 33%, GObf is 213 and GOaf is 192. The luminance deviation amount (GOaf×2−GObf) is 171. Thus, according to the gradation conversion characteristic in the present exemplary embodiment, a luminance deviation amount becomes greater as the light amount control value becomes smaller.

As described in FIG. 15, the conversion characteristic in the range of input gradation values of 0 or more and less than 64 is such that the converted gradation value increases in proportion to the reciprocal of the light amount control value Bc. Therefore, for input gradation values in the range of 0 or more and less than 64, the product of the converted gradation value and the light amount control value Bc has the same value regardless of the light amount control value Bc. In other words, if the input gradation value falls within the range of 0 or more and less than 64, an image of the same luminance is projected onto the projection plane irrespective of the light amount control value Bc. For input gradation values in the range of 64 or more, the product of the converted gradation value and the light amount control value Bc varies in value depending on the light amount control value Bc. If the input gradation value is in the range of 64 or more, images of different luminance are projected onto the projection plane as the light amount control value Bc varies.

As described above, the smaller the light amount control value Bc, the greater the luminance deviation amount. Further, the greater the gradation value before the edge blend processing, the greater the luminance deviation amount.

In the present exemplary embodiment, the projection system then reduces the luminance deviation amount by correcting the light amount control value Ba determined by the calculation unit 303 using a correction coefficient that changes depending on the reciprocal of the light amount control value Ba and the gradation value before the edge blend processing is performed. The processing of the index value calculation unit 1401 and the control value correction unit 1402 according to the present exemplary embodiment will be described below.

The index value calculation unit 1401 determines an index value Yd indicating the degree of luminance deviation based on the light amount control value Ba and the specific APL obtained by the specific APL acquisition unit 302.

If the luminance deviation amount is calculated for all the pixels, enormous amounts of calculations are required. In the present exemplary embodiment, the projection system then determines the index value Yd by using the APL of the edge blend region as a representative value of the gradation value GIbf before the edge blend processing is performed. In the present exemplary embodiment, the specific APL acquisition unit 302 uses the edge blend region as the specific region. This eliminates the need to provide a new APL acquisition unit.

The projection apparatus 100 determines the gradation value GIbf before the edge blend processing, by multiplying the gradation value GIaf after the edge blend processing by the reciprocal a of a gradation value reduction rate of the pixel at the center of the edge blend region resulting from the edge blend processing. In the present exemplary embodiment, a is 2.

The index value calculation unit 1401 determines the index value Yd by using the following Eq. 3:

Index value Yd=F(a×specific APL)×(1/(light amount control value Ba/100)). (Eq. 3)

The function F in Eq. 3 is given by the following Eq. 4:

$$F ( x ) = \{ \begin{matrix}0 & ( if x < 64 ) \\ ( x - 64 ) / 64 & ( if 64 \leq x < 128 ) \\ 1 & ( if 128 \leq x )\end{matrix} . \qquad ( Eq . 4 )$$

The control value correction unit 1402 corrects the light amount control value Ba to calculate a light amount control value Bah based on the index value Yd determined by the index value calculation unit 1401, using the following Eq. 5:

Light amount control value Bah=light amount control value Ba×(1+β×index value Yd/YdMax). (Eq. 5)

β in Eq. 5 is a coefficient used to adjust the degree of suppression of luminance deviation. The value of β is defined in advance. The greater the value of β, the higher the degree of suppression of luminance deviation. In the present exemplary embodiment, β=1. YdMax in Eq. 5 is a maximum possible value of the index value Yd. The value of YdMax is defined in advance. If the possible range of optical amount control values (range in which the light amount is constructionally controllable) is defined to be 25% to 100%, YdMax is 4 from Eq. 3. If the light amount control value Bah determined by using Eq. 5 exceeds 100%, the control value correction unit 1402 corrects the light amount control value Bah to be 100%. As described above, the projection system reduces luminance deviation by increasing the light amount control value Bah as the index value Yd increases and by controlling the light amount based on the light amount control value Bah such that the gradation conversion characteristic approaches a linear characteristic.

In the present exemplary embodiment, the control value correction unit 1402 corrects the light amount control value Ba by using Eq. 5. However, the control value correction unit 1402 may correct the light amount control value Ba by using other methods as long as the light amount control value Ba can be brought closer to 100% when a luminance deviation occurs. For example, suppose that a coefficient table G storing correction coefficients corresponding to possible values of α×the specific APL and possible values of the light amount control value Ba is stored in the ROM 111 in advance. In such a case, the control value correction unit 1402 may correct the light amount control value Ba by obtaining a correction coefficient corresponding to α×the specific APL and the light amount control value Ba from the coefficient table G, and multiplying the light amount correction value Ba by the obtained correction coefficient. The correction coefficients stored in the coefficient table G are coefficients such that the higher the specific APL and the smaller the light amount control value Ba, the greater the value of the corresponding correction coefficient. The control value correction unit 1402 corrects the light amount control value Ba by using the following Eq. 6:

Light amount control value Bah=light amount control value Ba×G(α×specific APL, light amount control value Ba), (Eq. 6)

where G(α×specific APL, light amount control value Ba) is the correction coefficient corresponding to α×the specific APL and the light amount control value Ba, stored in the coefficient table G.

The control value correction unit 1402 transmits the corrected light amount control value Bah to the other projection apparatus 100 via the communication unit 193. More specifically, the projection apparatus 100a transmits the determined corrected light amount control value Bah to the projection apparatus 100b. The projection apparatus 100b transmits the determined corrected light amount control value Bah to the projection apparatus 100a.

The average processing unit 1403 calculates an average value of the corrected light amount control value Bah determined by the control value correction unit 1402 of the own apparatus and the corrected light amount control value Bah received from the other projection apparatus 100. The average value will hereinafter be referred to as a light amount control value Baa.

The maximum specific APL determination unit 1404 compares the specific APL transmitted from the specific APL acquisition unit 302 and a specific APL received from the other projection apparatus 100, and outputs the highest to the determination unit 305 as the final value of the APL of the specific region (hereinafter, maximum specific APL).

The determination unit 305 selects either one of the light amount control values Bah and Baa based on the value of the maximum specific APL output from the maximum specific APL determination unit 1404. The determination unit 305 outputs the selected value to the light source control unit 160 and the correction unit 306 as the final light amount control value Bc. More specifically, if the maximum specific APL value is 64 or more, the determination unit 305 selects the light amount control value Baa. If the maximum specific APL value is less than 64, the determination unit 305 selects the light amount control value Bah. If the light amount control value Bc is less than 25%, the determination unit 305 corrects the light amount control value Bc to 25%.

In the present exemplary embodiment, if the specific region including the overlapping region of the image input to each projection apparatus 100 has an average gradation value of less than 64, the light source 161 is controlled by the light amount control value Bah determined by each projection apparatus 100. The correction unit 306 of each projection apparatus 100 then corrects the gradation values. This prevents the occurrence of a difference in luminance on the projection plane even if the projection apparatuses 100a and 100b have different light amount control values. The projection system can thus suppress the occurrence of a difference in luminance level in the overlapping region (edge blend region), while the projection system lowers black luminance, and reduces a drop in luminance.

If the specific region including the overlapping region of the image input to each projection apparatus 100 has an average gradation value of 64 or more, the effect of the amount of correction by the correction unit 306 becomes smaller than the amount of correction to the light amount. The reason is that, as described in FIG. 18, the gradation values are converted (corrected) based on a conversion characteristic that is gentler than the one proportional to the reciprocal of the light amount control value Bc if the average gradation value of the specific region is 64 or more. Accordingly, a difference in luminance level can occur in the overlapping region if the light source 161 is controlled by the light amount control value Bah determined by each projection apparatus 100. In such a case, the projection apparatuses 100 control the light amounts of their light sources 161 by using the light amount control value Baa that is common between the projection apparatuses 100. This can suppress the occurrence of a difference in luminance level in the overlapping region (edge blend region).

As described above, according to the processing of the present exemplary embodiment, the projection system can reduce luminance deviation, suppress the occurrence of a difference in luminance level between the projection images, and suppress a drop in the contrast of the entire projection image displayed on the projection plane even if the DC processing is performed after the edge blend processing.

In the present exemplary embodiment, the projection system performs the edge blend processing within the projection apparatuses 100. In another example, the projection apparatuses 100 may accept input of images on which the edge blend processing has been performed beforehand. For example, the video distribution apparatus 103 may perform the edge blend processing on the overlapping portions of the images A and B in advance. In such a case, the projection apparatuses 100a and 100b may each use a value stored as a frequently-used value in the ROM 111 as the coefficient α. Further, the projection apparatuses 100a and 100b may each accept a value designated by the user and use the accepted value as the coefficient α.

### Other Exemplary Embodiments

In the first to fifth exemplary embodiments, the projection apparatuses included in the projection system perform the processing described in the respective exemplary embodiments to determine the gradation values and light amounts about the images to be projected. However, if, for example, an information processing apparatus connected to the projection apparatuses controls the projection apparatuses, the information processing apparatus may perform the processing described in the exemplary embodiments to determine the gradation values and light amounts about the images to be projected. In such a case, a CPU of the information processing apparatus implements functions similar to those of the projection apparatuses according to the first to fifth exemplary embodiments and processing similar to that of the projection apparatuses according to the first to fifth exemplary embodiments by performing the processing based on a program stored in a ROM of the information processing apparatus. For example, if, in the first exemplary embodiment, the video distribution apparatus 103 controls the projection apparatuses 100, the video distribution apparatus 103 may determine the gradation values and light amounts about the images to be projected by the projection apparatuses 100.

In the first to fifth exemplary embodiments, the projection system implements the dynamic contrast processing by controlling the light amounts of the light sources 161. However, the projection system may include diaphragms on the optical paths of the light sources 161 and control the light amounts by controlling the aperture values of the diaphragms. In the first to fifth exemplary embodiments, the projection system determines the index of luminance (gradation value) of each pixel in an image and the amount of light used to project the image based on the APL (average gradation value) of a region defined in the image. However, the projection system may perform similar processing based on an average luminance value in the region defined in the image. The luminance value is an example of an index indicating the degree of luminance of each pixel. Alternatively, the projection system may determine a luminance value, not a gradation value, as an index of luminance of each pixel in the image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2018-077727, filed Apr. 13, 2018, and No. 2019-007693, filed Jan. 21, 2019, which are hereby incorporated by reference herein in their entirety.

What is claimed is:

1. A projection apparatus, among a plurality of projection apparatuses configured to project a plurality of projection images side by side as a single image, the projection apparatus comprising:
a light emission unit;
a control unit configured to control the light emission unit to emit a light amount based on a brightness value of a first image signal; and
a projection unit configured to modulate light emitted from the light emission unit based on the first image signal and project a first projection image on a projection plane,
wherein the control unit is configured to control the light amount emitted by the light emission unit based on a brightness value of a first region of the first image signal, the first region adjoining a second projected image projected by another projection apparatus.

2. The projection apparatus according to claim 1, wherein the control unit is configured to control the light emission unit using a higher amount between a first light amount corresponding to the brightness value of the first region and a second light amount corresponding to a brightness value of a second region of the first image signal, the second region being wider than the first region.

3. The projection apparatus according to claim 1, further comprising a setting unit configured to set a control mode of the light emission unit,
wherein the control unit is configured to, if the control mode of the light emission unit is set to a first control mode by the setting unit, control the light emission unit with the light amount based on the brightness of the first region of the first image, and if the control mode of the light emission unit is set to a second control mode by the setting unit, control the light emission unit with a light amount based on the brightness of a second region of the first image, the second region being wider than the first region.

4. The projection apparatus according to claim 3, wherein the second region is an entire region of the first image.

5. The projection apparatus according to claim 1, further comprising a region setting unit configured to set the first region based on a designation from a user.

6. The projection apparatus according to claim 1, wherein the control unit is configured to control the light emission unit such that the greater an average value of pixel values included in the first region of the first image is, the higher the light amount is.

7. The projection apparatus according to claim 1, wherein the first region is a region including at least any one of a top end portion, a bottom end portion, a left end portion, and a right end portion of the first image.

8. A method for controlling a projection apparatus among a plurality of projection apparatuses configured to project a plurality of projection images side by side as a single image, the projection apparatus including a light emission unit and a modulation unit, the method comprising:
controlling the light emission unit to emit a light amount based on brightness of a first image; and
controlling the modulation unit to modulate light emitted from the light emission unit based on the first image and project an image onto a projection plane,
wherein the light amount of the light emission unit is controlled in the light emission control based on the brightness of a first region of the first image, the first region adjoining a second image projected by another projection apparatus.

9. The method for controlling a projection apparatus according to claim 8, wherein the light emission unit is controlled in the light emission control to emit a higher amount between a first light amount corresponding to the brightness of the first region, and a second light amount corresponding to the brightness of a second region of the first image, the second region being wider than the first region.

10. The method for controlling a projection apparatus according to claim 8, further comprising setting a control mode of the light emission unit,
wherein if the control mode of the light emission unit is set to a first control mode, the light emission unit is controlled in the light emission control to emit the light amount based on the brightness of the first region of the first image, and
wherein if the control mode of the light emission unit is set to a second control mode, the light emission unit is controlled to emit a light amount based on the brightness of a second region of the first image, the second region being wider than the first region.

11. The method for controlling a projection apparatus according to claim 10, wherein the second region is an entire region of the first image.

12. The method for controlling a projection apparatus according to claim 8, further comprising setting the first region based on a designation from a user.

13. The method for controlling a projection apparatus according to claim 8, wherein the light emission unit is controlled in the light emission control such that the greater an average value of pixels values included in the first region of the first image is, the higher the light amount is.

14. The method for controlling a projection apparatus according to claim 8, wherein the first region is a region including at least any one of a top end portion, a bottom end portion, a left end portion, and a right end portion of the first image.

15. A non-transitory storage medium storing a program for a processor to perform a method for controlling a projection apparatus among a plurality of projection apparatuses configured to project a plurality of projection images side by side as a single image, the projection apparatus including a light emission unit and a modulation unit, the method comprising:
controlling the light emission unit to emit a light amount based on brightness of a first image; and
controlling the modulation unit to module light emitted from the light emission unit based on the first image and project an image on a projection plane,
wherein the light amount of the light emission unit is controlled in the light emission control based on the brightness of a first region of the first image, the first region adjoining a second image projected by another projection apparatus.
